(19) United States
(12) Patent Application Publication
(10) Pub. No.: US 2008/0197912 A1
(43) Pub. Date: Aug. 21, 2008

(54) Circuit arrangement for generating a temperature-compensated voltage or current reference value

(75) Inventor: Axel Pannwitz, Radebeul (DE)

Correspondence Address: Muncy, Geissler, Olds & Lowe, PLLC, P.O. BOX 1364, FAIRFAX, VA, 22038-1364, US

(73) Assignee: Atmel Germany GmbH, Heilbronn (DE)

(21) Appl. No.: 11/958,339

(22) Filed: Dec. 17, 2007

Related U.S. Application Data
(60) Provisional application No. 60/875,809, filed on Dec. 20, 2006.

(30) Foreign Application Priority Data
Dec. 18, 2006 (DE) DE102006061512.3

(51) Int. Cl. G05F 3/02

(52) U.S. Cl. 327/539

(57) ABSTRACT

A circuit arrangement for generating a temperature-compensated voltage or current reference value (UREF) from a supply voltage (VCC) based on the bandgap principle comprises a PTAT circuit (201) for generating a PTAT signal (I1) proportional to the absolute temperature, a CTAT circuit (202) for generating a CTAT signal (UBE) inversely proportional to the absolute temperature, whereby for generating the temperature-compensated reference value (UREF), the PTAT signal (UBE) and the CTAT signal (I1) are superimposed, and a reference value monitoring circuit (203a, 203b, 203), which generates a reference value monitoring signal (UREF_OK) that indicates whether the reference value (UREF) is validly generated or not. The reference value monitoring circuit (203) is formed in such a way that it evaluates a current (I2) and/or a voltage in the CTAT circuit (202) and/or in the PTAT circuit (201) for generating the reference value monitoring signal (UREF_OK).

The invention relates to a circuit arrangement for generating a temperature-compensated voltage or current reference value from a supply voltage based on the bandgap principle.

The bandgap principle is described by way of example in the textbook Halbleiter-Schaltungstechnik [Semiconductor Circuit Engineering], U. Tietze and Ch. Schenk, 10^{th} edition, published by Springer Verlag, on page 558ff under the heading Bandgap Reference.

According to the bandgap principle, a proportional-to-absolute temperature (PTAT) signal is generated which is proportional to the absolute temperature. In addition, a complementary-to-absolute temperature (CTAT) signal is generated which is inversely proportional to the absolute temperature. To generate the temperature-compensator reference value, the PTAT signal and the CTAT signal are superimposed in such a way that the arising signal, i.e., the reference value, is substantially temperature-independent.

The temperature-compensated or temperature-independent reference value generated in this way can be used as a temperature-independent reference parameter, for example, for monitoring the supply or battery voltage. In this case, for example, the battery voltage is divided by means of a voltage divider and the divided value is compared with the voltage reference value by a comparator. The result of the comparison indicates whether the battery voltage exceeds or falls below a threshold value dependent on the voltage reference value.

If, however, the reference value is also generated from the battery voltage, said value is typically generated incorrectly, typically too small, when the battery voltage has values that are not sufficient for generating the reference value. The comparator, which uses this incorrectly generated reference value, then generates an output signal, which wrongly indicates a proper battery voltage.

To avoid such errors based on an improperly generated reference value, circuits for monitoring the battery or supply voltage are typically used, which release the reference value generation only in the case of a sufficient supply voltage. When the monitoring circuits are made, for example, of MOS transistors, it is necessary because of the parameter scattering that the release of the reference value generation occurs at a great safety margin to a threshold value, starting at which the reference value generation in fact operates error-free. A great circuitry expenditure is necessary, however, to reduce this safety margin considerably.

The invention has as its object to make available a circuit arrangement for generating a temperature-compensated voltage or current reference value from a supply voltage based on the bandgap principle, which enables a reliable and simple to implement monitoring of the validity of the generated reference value.

The invention achieves this object by means of a circuit arrangement having the features of claim 1.

The circuit arrangement of the invention for generating a temperature-compensated voltage or current reference value from a supply voltage based on the bandgap principle comprises a PTAT circuit for generating a PTAT signal proportional to the absolute temperature, a CTAT circuit for generating a CTAT signal inversely proportional to the absolute temperature, whereby for generating the temperature-compensated reference value, the PTAT signal and the CTAT signal are superimposed, and a reference value monitoring circuit, which generates a reference value monitoring signal that indicates whether the reference value is generated validly or not. The reference value monitoring circuit is formed in such a way that it evaluates a current and/or a voltage in the CTAT circuit and/or in the PTAT circuit for generating the reference value monitoring signal. The voltages or currents occurring in the CTAT circuit or the PTAT circuit indicate whether the CTAT and/or PTAT circuit or the entire circuit arrangement are sufficiently supplied with operating power to generate a valid reference value. Therefore, the CTAT and/or PTAT circuit, which are always part of a bandgap reference, can be used for generating the reference value monitoring signal, as a result of which the reference value monitoring signal can be generated reliably and at low circuitry cost. The circuit arrangement can be formed as an integrated circuit or be part of an integrated circuit. In a development of the circuit arrangement, the CTAT circuit comprises a first bipolar transistor, whereby the base terminal and the collector terminal of the first bipolar transistor are connected and a voltage that forms the CTAT signal is applied at the base-emitter path of the first bipolar transistor. The base-emitter path of the first bipolar transistors has a desired temperature profile, i.e., is inversely proportional to the absolute temperature. It is preferred that the current flowing through the first bipolar transistor is evaluated for generating the reference value monitoring signal. A current threshold value detector or current comparator is also preferably provided, which is formed to compare the current flowing through the first bipolar transistor with a preset current threshold value, whereby the reference value-monitoring signal indicates a valid reference value, when the current flowing through the first bipolar transistor exceeds the preset current threshold value. The current flowing through the first bipolar transistor indicates whether the circuit has reached an operating state that is sufficient for generating a valid reference value. Therefore, the current flowing through the first bipolar transistor is suitable for use as a basis for generating the reference value monitoring signal.

In a development of the circuit arrangement, the PTAT circuit comprises a PTAT current generating circuit, generating a PTAT current as the PTAT signal, and a first transistor. The CTAT circuit comprises a second transistor, a first resistor, and a second resistor, whereby the first transistor, the first resistor, the first bipolar transistor, and the second resistor are looped in series between the supply voltage and a reference potential and form a first current path. The first transistor and second transistor are connected to one another in such a way that they form a current mirror that mirrors the PTAT current multiplied by a first factor in the first current path and that the temperature-compensated voltage reference value is applied at a connection node of the second transistor and the first resistor. The first factor or a transformation ratio, i.e., a quotient of the PTAT current and the mirrored current, can be set, for example, by suitable selection of a size ratio or area ratio of the first and the second transistor. In addition or alternatively, the first and/or the second transistor can also be formed by the parallel connection of a plurality of transistors, as a result of which integer multiples or fractions of the PTAT current can be generated as a function of the multiplicity.

In a development of the circuit arrangement, the reference value monitoring circuit comprises a second bipolar transistor, whereby the first bipolar transistor and the second bipolar transistor are connected to one another in such a way that they form a current mirror that mirrors a current flowing through the first bipolar transistor multiplied by a second factor in the second bipolar transistor, whereby the second factor depends on the current flowing through the first bipolar transistor, and increases in particular when the current flowing through the first bipolar transistor increases. In this way, the current flowing through the first bipolar transistor in the CTAT circuit in the reference value monitoring circuit can be monitored, for example, by means of a current comparator, whereby when the current flowing through the first bipolar transistor is exceeded, the reference value monitoring signal can be generated in such a way that a valid reference value is indicated.

In a development of the circuit arrangement, the reference value monitoring circuit comprises a third transistor, particularly in the form of a PMOS transistor, whereby the third transistor and second bipolar transistor are looped in series between the supply voltage and a reference potential and form a second current path.

In a development of the circuit arrangement, the reference value monitoring circuit comprises a fourth transistor, particularly in the form of a PMOS transistor, a fifth transistor, particularly in the form of a PMOS transistor, and a sixth transistor, particularly in the form of an NMOS transistor, whereby the fourth and fifth transistor are connected to one another in such a way that they form a current mirror that mirrors a current flowing through the fourth transistor multiplied by a third factor in the fifth transistor, the fourth transistor is connected with its drain terminal or its collector terminal, and its gate terminal or its base terminal to the collector terminal of the second bipolar transistor, and the fifth transistor and sixth transistor are looped in series between the supply voltage and the reference potential, whereby the reference value monitoring signal is applied at a connection node of the fifth and sixth transistor, and the fifth and sixth transistor form a third current path.

In a development of the circuit arrangement, the reference value monitoring circuit comprises a seventh transistor, particularly in the form of a PMOS transistor, and an eighth transistor, particularly in the form of an NMOS transistor, whereby the seventh and eighth transistors are looped in series between the supply voltage and the reference potential and form a fourth current path, the seventh transistor and the first transistor are connected to one another in such a way that they form a current mirror that mirrors the PTAT current multiplied by a fourth factor in the fourth current path, and the eighth transistor and sixth transistor are connected to one another in such a way that they form a current mirror that mirrors the current flowing in the fourth current path multiplied by a fifth factor in the third current path.

In a development of the circuit arrangement, the first factor is about 4, the second factor is in a range between about 1/10 and about 1, the third factor is about 100, the fourth factor is about 1, and the fifth factor is about 1.

The invention will be described hereinafter with reference to the drawings. The figures show the following schematically:

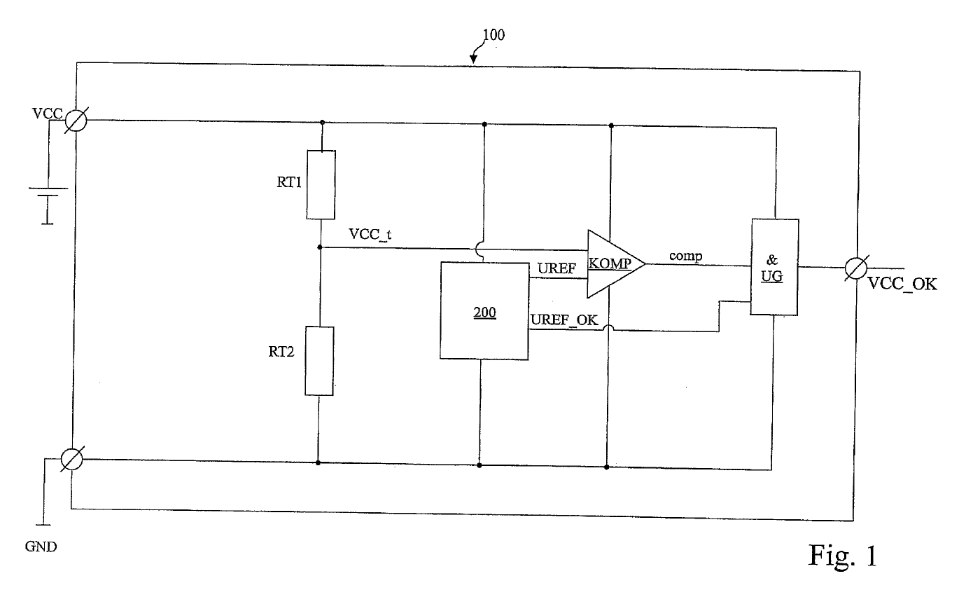

FIG. 1 shows a basic circuit diagram of a battery-driven system, which comprises a circuit arrangement of the invention for generating a temperature-compensated voltage reference value from a battery voltage based on the bandgap principle;

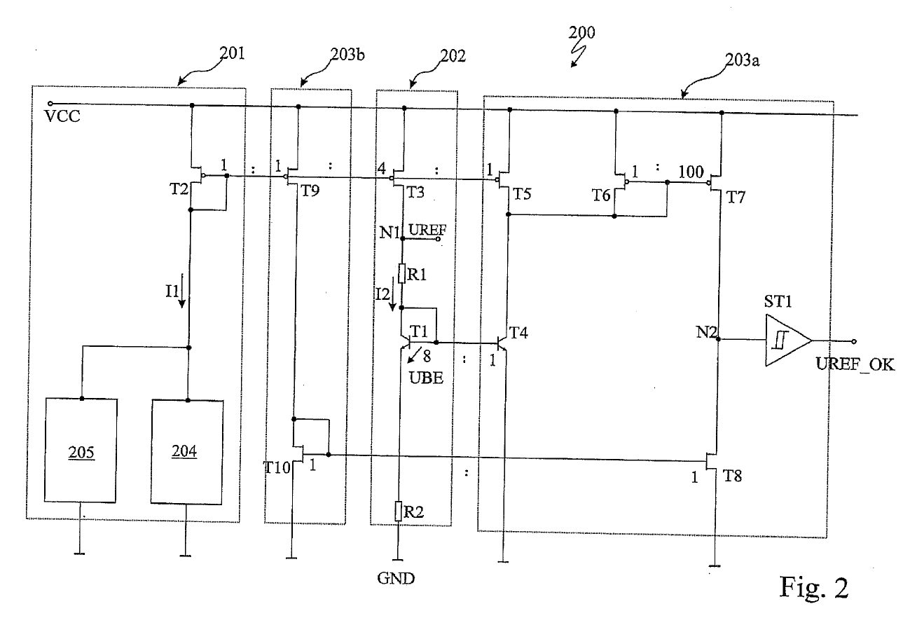

FIG. 2 shows a circuit diagram of the circuit arrangement of the invention for generating the temperature-compensated voltage reference value of FIG. 1; and

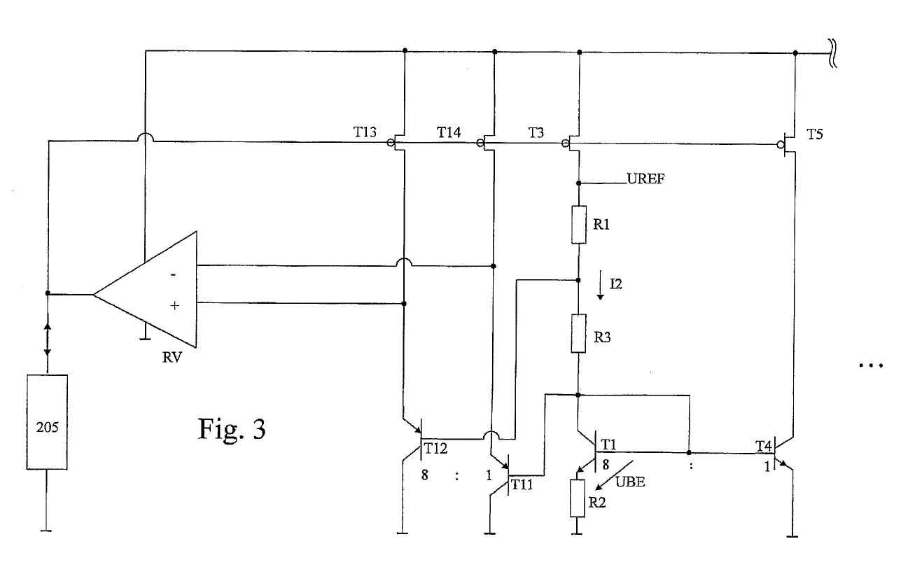

FIG. 3 shows a circuit diagram of another embodiment of a circuit arrangement for generating a temperature-compensated voltage reference value.

FIG. 1 shows a basic circuit diagram of a battery-driven system 100, which comprises a circuit arrangement of the invention 200 for generating a temperature-compensated voltage reference value UREF from a battery voltage or supply voltage VCC based on the bandgap principle.

When the battery or supply voltage VCC falls below a threshold value, the reference value UREF can no longer be generated properly or validly by circuit arrangement 200. To indicate this state to peripheral circuit parts, circuit arrangement 200 generates a reference value monitoring signal UREF_OK, which indicates whether the voltage reference value UREF is generated validly or not.

The mode of operation of a supply voltage monitoring of battery-driven system 100 will be described hereinafter. The supply voltage VCC is first divided into a value VCC_t by means of a voltage divider comprising resistors RT1 and RT2. A comparator KOMP is applied at a first input with the divided supply voltage VCC_t and at a second input with the voltage reference value UREF generated by circuit arrangement 200. The comparator KOMP compares the signals UREF and VCC_t at its inputs and generates an output signal comp depending on the result of the comparison.

If the supply voltage VCC is too low for valid generation of the voltage reference value UREF, the voltage reference value UREF is about 0 V. In this case, the comparator KOMP generates its output signal comp with a level that indicates that the divided supply voltage VCC_t is greater than the voltage reference value UREF. For this reason, the signal comp cannot be used directly for indicating whether the supply or battery voltage VCC has a sufficient value, which in the case of normal operation depends on the validly generated voltage reference value UREF. To generate a signal VCC_OK, which indicates that the supply voltage VCC has a sufficient value, therefore, the signal comp is ANDed to the signal UREF_OK in an AND gate U1 for generating the signal VCC_OK. If the supply voltage VCC is too low for generating a valid voltage reference value UREF, the reference value monitoring signal UREF_OK is generated with a logic low level, as a result of which the signal VBAT_OK is also generated with a logic low level.

If the supply voltage VCC is sufficient for generating a valid voltage reference value UREF, the reference value monitoring signal UREF_OK is generated with a logic high level. If for this case the voltage reference value UREF is greater than the divided supply voltage VCC_t, the comparator KOMP generates its output signal comp with a logic low level, as a result of which the signal VBAT_OK is again-generated with a logic low level. If finally the supply voltage VCC and thereby the divided supply voltage VCC_t increase further, so that the voltage reference value UREF becomes smaller than the divided supply voltage VCC_t, the comparator KOMP generates its output signal comp with a logic high level. Because both input signals of the AND gate U1 now have a logic high level, the signal VCC_OK is output with a logic high level; i.e., a sufficient supply voltage VCC is indicated.

FIG. 2 shows a detailed circuit diagram of circuit arrangement 200 of the invention for generating the temperature-compensated voltage reference value UREF of FIG. 1.

Circuit arrangement 200 comprises a PTAT circuit 201 for generating a PTAT signal in the form of a PTAT current I1 proportional to the absolute temperature, a CTAT circuit 202 for generating a CTAT signal in the form of a CTAT voltage. UBE inversely proportional to the absolute temperature, whereby to generate the temperature-compensated voltage reference value UREF, PTAT current I1 and CTAT voltage UBE are superimposed in CTAT circuit 202, and a reference value monitoring circuit 203 with a first part 203a and a second part 203b, which generates the reference value monitoring signal UREF_OK, which indicates whether the voltage reference value UREF has been validly generated or not. Reference value monitoring circuit 203 is formed in such a way that it evaluates a current I2 in CTAT circuit 202 for generating the reference value monitoring signal UREF_OK.

PTAT circuit 201 comprises a PTAT current generating circuit 204, which generates PTAT current I1, a startup block 205, and a PMOS transistor T2, whereby PMOS transistor T2 is looped between supply voltage VCC and PTAT current generating circuit 204. Startup block 205 is used for starting PTAT circuit 201 and supplies an initial current, which is again turned off after a successful start of PTAT current generating circuit 204 by said circuit.

CTAT circuit 202 comprises a PMOS transistor T3, a resistor R1, a bipolar transistor T1, whereby the base terminal and the collector terminal of bipolar transistors T1 are connected and the CTAT voltage UBE is applied at the base-emitter path of bipolar transistors T1, and a resistor R2, whereby transistor T3, resistor R1, bipolar transistor T1, and resistor R2 are looped in series between supply voltage VCC and a reference potential, here ground GND, and form a first current path Transistor T2 of PTAT circuit 201 and transistor T3 of CTAT circuit 202 are connected to one another in such away that they form a current mirror that mirrors PTAT current I1 multiplied by a factor of 4 in the first current path. The temperature-compensated voltage reference value UREF is applied at a connection node. N1 of transistor. T3 and resistor R1. PTAT current I1 and the CTAT voltage UBE are superimposed to form the temperature-compensated voltage reference value UREF by the shown connection.

Reference value monitoring circuit 203 comprises a bipolar transistor T4, whereby bipolar transistor T1 of CTAT circuit 202 and bipolar transistor T4 of reference value monitoring circuit 203 are connected to one another in such a way that they form a current mirror that mirrors a current I2 flowing through bipolar transistor T1 multiplied by a factor of ⅛ in bipolar transistor T4. A transistor T5 and bipolar transistor T4 are looped in series between supply voltage VCC and ground GND and form a second current path.

Reference value monitoring circuit 203 comprises furthermore a PMOS transistor T6, a PMOS transistor T7, and an NMOS transistor T8. Transistors T6 and T7 are connected to one another in such a way that they form a current mirror that mirrors a current flowing through transistor T6 multiplied by a factor of 100 in transistor T7. PMOS transistor T6 is connected with its drain terminal and its gate terminal to the collector terminal of bipolar transistor T4 and the drain terminal of transistor T5. Transistor 17 and transistor T8 are looped in series between supply voltage VCC and ground GND, whereby the reference value monitoring signal UREF_OK is applied at a connection node N2 of transistors T7 and T8, and transistors T7 and T8, connected as shown, form a third current path. In the shown exemplary embodiment, for conditioning the signal applied at node N2, an optional Schmitt trigger ST1 is also provided, at whose output the conditioned reference value monitoring signal UREF_OK is output. Reference value monitoring circuit 203 comprises in its part 203b a PMOS transistor T9 and an NMOS transistor T10, which are looped in series between supply voltage VCC and ground GND and form a fourth current path. Transistor T9 and transistor T2 are connected to one another in such a way that they form a current mirror that mirrors PTAT current I1 multiplied by a factor of 1 in the fourth current path. Transistor T10 and transistor T8 are connected to one another in such a way that they form a current mirror that mirrors the current flowing in the fourth current path multiplied by a factor of 1 in the third current path.

In the shown circuit arrangement, bipolar transistor T1 required for generating the CTAT voltage UBE is also used for generating the reference value monitoring signal UREF_OK, in that together with other circuit parts, it forms a current comparator or a current threshold value detector. If current I2 is sufficient for valid generation of the voltage reference value UREF, the current threshold value detector causes a toggling of the potential at node N2, as a result of which the signal UREF_OK with a logic high level is generated. A switching threshold of the current threshold value detector can be set by suitable selection of a size ratio of transistors T3 and T5, a size ratio of transistors T1 and T4, and a resistance value of resistor R2. The aforementioned parameters can be selected, for example, in such a way that switching of the signal UREF_OK occurs when the current I2 exceeds 75% of its nominal value.

The operation of the shown circuit arrangement is to be clarified once again briefly hereinafter. A low current I1 or I2 flows at a low supply voltage VCC. Due to the selected size or coupling ratio or factors between T3 and T5 and T1 and T4, transistor T5 completely supplies the current flowing through transistor T4; i.e., no current flows through transistor T6 and therefore also no current through transistor T7. The current mirror of transistors T10 and T8 therefore has the result that node N2 is pulled to ground, as a result of which the signal UREF_OK is output with a low level. The contribution of resistor R2 can be disregarded with low currents I1 or I2.

When the current I1 or I2 increases with an increasing supply voltage VCC, because of resistor R2 the ratio between current I1 flowing through transistor T1 and the current flowing through transistor T4 changes from 8 to 1 in the direction of smaller values, for example, 7 to 1, 6 to 1, etc. If the ratio falls below values from 4 to 1, a current begins to flow through transistor T6, because the current supplied by transistor T5 is no longer sufficient. Said current flowing through transistor T6 is converted with a ratio of 1 to 100 in transistor T7, as a result of which the potential at node. N2 is pulled to VCC. This has the effect that the signal UREF_OK shifts from a low level to a high level, as a result of which the validity of the voltage reference value UREF is indicated.

FIG. 3 shows a circuit diagram of another embodiment of a circuit arrangement for generating a temperature-compensated voltage reference value, which comprises a preferred embodiment of the PTAT signal generation shown in FIG. 2. Elements whose function corresponds to that of elements of FIG. 1 or FIG. 2 are provided with identical reference characters. Elements T6 to T10 and ST1 are not shown for reasons of clarity, but, appropriately connected, they can also be a component of the embodiment shown in FIG. 3.

For PTAT signal generation, PMOS transistors T13 and T14, PNP bipolar transistors T11 and T12, a resistor R3, and a control amplifier RV are provided. Transistors T13 and T12 are looped in series between supply voltage VCC and ground GND. Transistors T14 and T11 are looped in series between supply voltage VCC and ground GND. The emitter of transistor T12 is connected to the non-inverting input of control amplifier RV and the drain terminal of transistor T13. The emitter of transistor T11 is connected to the non-inverting input of control amplifier RV and the drain terminal of transistor T14. The base of transistor T12 is connected to a first terminal of resistor R3 and the base of transistor T11 is connected to the other terminal of resistor R3. Transistor T12 is eight times as large as transistor T11.

The shown configuration in the form of a closed control loop with the control amplifier RV has the effect that current I2 through the current path having transistors T1 and T3 and resistors R1 to R2 increases proportional to the temperature, to compensate accordingly for the decreasing base-emitter voltages of transistors T11 and T12, so that the input voltage of the control amplifier remains substantially 0 V. The voltage declining at resistors R1 to R3 due to current I2 therefore forms the PTAT portion of the voltage reference value UREF and the base-emitter voltage UBE of transistor T1 the CTAT portion. The dimensioning of the components occurs in such a way that the voltage UREF is substantially temperature-independent.

To generate the reference value monitoring signal UREF_OK, the current I2 is evaluated as in FIG. 2; i.e., it is determined whether the current I2 exceeds a preset threshold value. A valid reference value UREF is indicated by the reference value monitoring signal UREF_OK, when current I2 exceeds the current threshold value.

The shown embodiments generate a temperature-stable voltage reference UREF and a PTAT current reference 11 with a self-test function. To generate a temperature-stabilized current reference, which is not shown, the shown circuit arrangements can be supplemented by additional components or circuit parts. To generate a temperature-stable current reference, for example, an additional circuit part can be provided that generates a CTAT current. The temperature-stable current reference is generated by superimposing the PTAT current I1 and the CTAT current. To this end, a control amplifier can be provided which makes sure that the voltage UBE is represented as a CTAT current across another resistor. The CTAT current is led out by means of a current mirror and combined with the PTAT current I1 in such a way that the current sum is temperature stable.

1. A circuit arrangement for generating a temperature-compensated voltage or current reference value (UREF) from a supply voltage (VCC) based on the bandgap principle, having
a PTAT circuit (201) for generating a PTAT signal (I1) proportional to the absolute temperature,
a CTAT circuit (202) for generating a CTAT signal (UBE) inversely proportional to the absolute temperature, whereby for generating the temperature-compensated reference value (UREF) the PTAT signal (UBE) and the CTAT signal (I1) are superimposed, and
a reference value monitoring circuit (203a, 203b, 203), which generates a reference value monitoring signal (UREF_OK) that indicates whether the reference value (UREF) is validly generated or not,
characterized in that
the reference value monitoring circuit (203) is formed in such a way that it evaluates a current (I2) and/or a voltage in the CTAT circuit (202) and/or in the PTAT circuit (201) for generating the reference value monitoring signal (UREF_OK).

2. The circuit arrangement according to claim 1, characterized in that the CTAT circuit (202) comprises:
a first bipolar transistor (T1), whereby the base terminal and the collector terminal of the first bipolar transistor (T1) are connected and a voltage (UBE) that forms the CTAT signal is applied at the base-emitter path of the first bipolar transistor (T1).

3. The circuit arrangement according to claim 2, characterized in that a current (I2) flowing through the first bipolar transistor (T1) is evaluated for generating the reference value monitoring signal (UREF_OK).

4. The circuit arrangement according to claim 3, characterized by a current threshold value detector, which is formed to compare the current (I2) flowing through the first bipolar transistor (T1) with a preset current threshold value, whereby the reference value monitoring signal (UREF_OK) indicates a valid reference value (UREF), when the current (I2) flowing through the first bipolar transistor (T1) exceeds the preset current threshold value.

5. The circuit arrangement according to any one of claims 2 through 4, characterized in that
the PTAT circuit (201) comprises:
a PTAT current generating circuit (204), generating a PTAT current (11) as the PTAT signal, and
a first transistor (T2),
the CTAT circuit (202) comprises:
a second transistor (T3),
a first resistor (R1), and
a second resistor (R2), whereby
the first transistor (T3), the first resistor (R1), the first bipolar transistor (T1), and the second resistor (R2) are looped in series between the supply voltage (VCC) and a reference potential (GND) and form a first current path,
the first transistor (T2) and second transistor (T3) are connected to one another in such a way that they form a current mirror that mirrors the PTAT current (11) multiplied by a first factor in the first current path, and
the temperature-compensated voltage reference value (UREF) is applied at a connection node (N1) of the second transistor (T3) and first resistor (R1).

6. The circuit arrangement according to claim 5, characterized in that the reference value monitoring circuit (203) comprises:
a second bipolar transistor (T4), whereby the first bipolar transistor (T1) and the second bipolar transistor (T4) are connected to one another in such a way that they form a current mirror that mirrors a current (I2) flowing through the first bipolar transistor (T1) multiplied by a second factor in the second bipolar transistor (T4), whereby the second factor depends on the current (I2) flowing through the first bipolar transistor (T1), and increases in particular when the current (I2) flowing through the first bipolar transistor (T1) increases.

7. The circuit arrangement according to claim 6, characterized in that the reference value monitoring circuit (203) comprises:
a third transistor (T5), whereby the third transistor (T5) and the second bipolar transistor (T4) are looped in series between the supply voltage (VCC) and a reference potential (GND) and form a second current path.

8. The circuit arrangement according to claim 7, characterized in that the reference value monitoring circuit (203) comprises:
a fourth transistor (T6),
a fifth transistor (T7), and
a sixth transistor (T8), whereby
the fourth and fifth transistor (T6, T7) are connected to one another in such a way that they form a current mirror that mirrors a current flowing through the fourth transistor (T6) multiplied by a third factor in the fifth transistor (T7),
the fourth transistor (T6) is connected with its drain terminal or its collector terminal and its gate terminal or its base terminal to the collector terminal of the second bipolar transistor (T4), and
the fifth transistor (T7) and sixth transistor (T8) are looped in series between the supply voltage (VCC) and the reference potential (GND), whereby the reference value monitoring signal (UREF_OK) is applied at a connection node (N2) of the fifth and sixth transistor (T7, T8), and the fifth and sixth transistor (T7, T8) form a third current path.

9. The circuit arrangement according to claim 8, characterized in that the reference value monitoring circuit (203) comprises:
a seventh transistor (T9) and
an eighth transistor (T10), whereby
the seventh and eighth transistors (T9, T10) are looped in series between the supply voltage (VCC) and the reference potential (GND) and form a fourth current path,
the seventh transistor (T9) and the first transistor (T2) are connected to one another in such a way that they form a current mirror that mirrors the PTAT current (I1) multiplied by a fourth factor in the fourth current path,
the eighth transistor (T10) and sixth transistor (T8) are connected to one another in such a way that they form a current mirror that mirrors the current flowing in the fourth current path multiplied by a fifth factor in the third current path.

10. The circuit arrangement according to claim 9, characterized in that the first factor is about 4, the second factor is in a range between about 1/10 and about 1, the third factor is about 100, the fourth factor is about 1, and the fifth factor is about 1.
